(19) United States
(12) Patent Application Publication
(10) Pub. No.: US 2001/0042272 A1
(43) Pub. Date: Nov. 22, 2001

(54) Travel pillow

(76) Inventor: George Vlasios Kontos, Harvey, LA (US)

Correspondence Address: Shawn D. Sentilles, Lobrano & Sentilles, LLC, P.O. Box 208, Belle Chasse, LA, 70037, US

(21) Appl. No.: 09/851,232

(22) Filed: May 8, 2001

Related U.S. Application Data
(60) Provisional application No. 60/203,029, filed on May 9, 2000.

(51) Int. Cl. B68G 5/00; A47C 20/02

(52) U.S. Cl. 5/652

(57) ABSTRACT

A travel pillow device for providing an armrest for an occupant of an automobile. The device includes a door engagement member, a cushion support member, and a cushion. The door engagement member is sized and configured to slide into a window slot of an automobile to thereby secure the device on the door. The cushion support member extends from an upper end of the door engagement member. The cushion is disposed on an upper surface of the cushion support member, and is positioned to provide support and comfort to the arm of the occupant when the door engagement member is secured on the door.

### CROSS REFERENCE TO RELATED APPLICATIONS

This patent application relates to and claims priority from Provisional Patent Application Serial No. 60/203,029, filed on May 9, 2000, which is pending.

### FIELD OF THE INVENTION

The present invention relates to pillows and cushions, and more particularly to a pillow adapted for use in automobiles and the like.

### BACKGROUND OF THE INVENTION

For hundred of years, pillows have been used to provide comfort and support to different regions of the body, including the head, neck, back, and posterior. Specialized pillows have been developed for travel, for animals, and for other needs. The present invention deals with an additional, specialized pillow. Around the world, millions of people travel in automobiles, trucks, and the like. The interior panels of automobile doors are provided with an armrest, which is typically made of a piece of molded plastic. This piece of plastic is rigid, firm, and hard. Consequently, when an occupant of a vehicle, such as the driver or a passenger, places his or her arm on an armrest, a level of discomfort may be experienced, particularly after an extended period of time.

There is thus a need for a travel pillow that meets the following objects and has the following characteristics.

### OBJECTS AND SUMMARY OF THE INVENTION

It is an object of the invention to provide a travel pillow which will reduce the discomfort of occupants in automobiles and the like by providing a cushioned armrest on which an arm can be rested.

It is another object of the invention to provide a travel pillow that can be fitted onto an existing automobile door.

These and other objects and advantages of the invention shall become apparent from the following general and preferred description of the invention.

Accordingly, a travel pillow is provided comprising generally a door engagement member, a cushion support member, and a cushion. The door engagement member is sized and configured to slide into a window slot of an automobile door to thereby secure the device on the door. The cushion support member extends from an upper end of the door engagement member. The cushion is disposed on an upper surface of the cushion support member, and is positioned to provide support and comfort to the arm of the occupant when the door engagement member is secured on the door. The door engagement member is preferably is a flat plate. The cushion support member preferably has a curved profile. A lower surface of the cushion support member is preferably configured to abut against an interior surface of the door to thereby enhance fit and placement of the device on the door. The door engagement member and the cushion support member are preferably molded from plastic. In a preferred embodiment, a cushion cover is disposed over the cushion.

In operation, the travel pillow is used by sliding the door engagement member into a window slot a door of an automobile. With the travel pillow thus secured on the door, an occupant of the automobile can rest his or her arm on the cushion of the travel pillow as desired.

### BRIEF DESCRIPTION OF THE DRAWINGS

FIG. 1 is a perspective view of one preferred embodiment of the invention.

FIG. 2 is a side view of one preferred embodiment of the invention.

FIG. 3 is a front view of one preferred embodiment of the invention.

### PREFERRED EMBODIMENTS OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

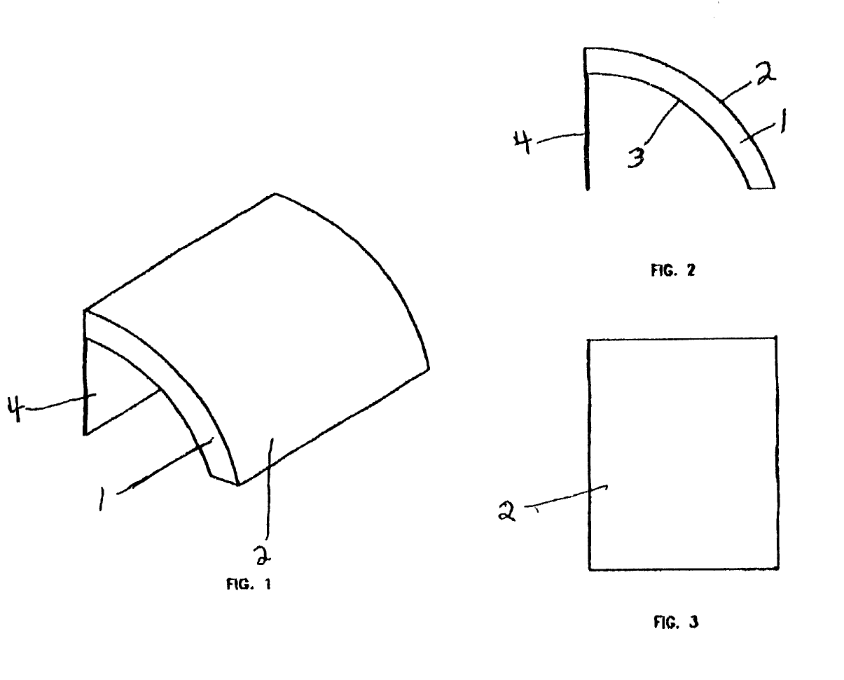

The device shown in FIGS. 1-3 is a travel pillow device for providing an armrest for an occupant of an automobile. As used herein, the term “automobile” shall refer to automobiles, trucks and other motor vehicles having doors that have a window slot, such that a sheet of window glass can be selectively rolled up or down in the window slot. The interface between the interior surface of the automobile window glass and interior side of the window slot provides a lengthwise slot into which an object can be inserted.

The invention has two distinct, yet attached parts, namely a cushion 1 and a frame 3, 4. The device is configured such that it can engage the window slot of an automobile door. As shown in FIG. 1, the frame of the invention includes a cushion support member or crosspiece 3 and a door engagement member or anchor 4. The door engagement member 4 extends downward from the cushion support member 3 such that the door engagement member 4 can be fitted into the window slot between the window and frame of the door of the automobile. The door engagement member 4 is sized and configured to slide into the window slot to thereby secure or anchor the device on the automobile door in a desired location. As shown in the side view profile of FIG. 2, the door engagement member 4 is preferably a flat plate.

As shown in FIGS. 1 and 2, the cushion support member or crosspiece 3 extends from an upper end of the door engagement member 4. The cushion support member 3 extends from the door engagement member 4 and preferably mirrors the design of the frame of the door of the automobile. As shown in FIG. 2, the cushion support member 3 preferably has a curved profile when viewed from the side. This configuration enables the cushion support member 3 to extend away from the door and then downward, to thereby extend over the portion of the door adjacent the window slot. A lower surface of the cushion support member 3 is preferably configured to abut against an interior surface of the door to thereby enhance fit and placement of the device on the door.

In a preferred embodiment, the door engagement member 4 and the cushion support member 3 are molded from plastic, and may be molded together in a uni-body construction. Plastic is lightweight, economical, and provides a product that is safe for the passenger.

A cushion or pillow 1 is disposed on an upper surface of the cushion support member 3. The cushion 1 is positioned to provide support and comfort to the arm of the passenger when the door engagement member 4 is secured on the door. The cushion 1 is constructed from a cushioning material that provides support yet cushion and comfort to the elbow or arm of an occupant, such as foam, rubber, or goosedown. The cushion 1 is attached to the cushion support member 3 to provide one integrated unit. The cushion 1 may be molded onto the cushion support member 3, such as by using foam injection molding or other conventional foam molding techniques, to thereby form a device of uni-body construction.

The cushion 1 may uncovered, such as a bare foam surface. The cushion 1 is preferably covered with a cushion cover 2. Preferred cushion covers 2 include cloth, fabric, plastic, vinyl, and leather. The cover 2 provides a cosmetic or aesthetic appearance, and may also provide additional cushioning or a pleasing texture for the arm of the passenger. The cover 2 may also serve to hold the cushion 1 on the cushion support member 3.

In operation, the travel pillow is used by sliding the door engagement member 4 into a window slot a door of an automobile. With the travel pillow thus secured on the door, an occupant of the automobile can rest his or her arm on the cushion 1 of the travel pillow as desired. Although the travel pillow is securely anchored on the automobile door during use, it can be removed as desired by pulling the door engagement member 4 out of the window slot. The travel pillow can be reinserted into the window slot as desired. The travel pillow is portable, and can be readily moved to other doors of the automobile or to another automobile.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A travel pillow device for providing an armrest for an occupant of an automobile, the device engaging a window slot of an automobile door, comprising:
a door engagement member, said door engagement member sized and configured to slide into the window slot to thereby secure said device on the door;
a cushion support member extending from an upper end of said door engagement member, and
a cushion disposed on an upper surface of said cushion support member, said cushion positioned to provide support and comfort to the arm of the occupant when said door engagement member is secured on the door.

2. The device of claim 1, wherein said door engagement member is a flat plate.

3. The device of claim 1, wherein said cushion support member has a curved profile.

4. The device of claim 1, wherein a lower surface of said cushion support member is configured to abut against an interior surface of the door to thereby enhance fit and placement of said device on the door.

5. The device of claim 1, wherein said door engagement member 4 and said cushion support member are molded from plastic.

6. The device of claim 1, further comprising a cushion cover, said cushion cover disposed over said cushion.

7. The device of claim 6, wherein said cushion cover is selected from the group consisting of cloth, plastic, vinyl, and leather.

8. A method of providing an arm rest for an occupant of an automobile comprising:
providing a travel pillow device, said travel pillow comprising a door engagement member, a cushion support member extending from an upper end of said door engagement member, and a cushion disposed on an upper surface of said cushion support member, said cushion positioned to provide support and comfort to the arm of the occupant when said door engagement member is secured on the door, and
sliding said door engagement member into a window slot a door of the automobile to thereby secure said travel pillow on the door.

9. The method of claim 8, wherein said door engagement member is a flat plate.

10. The method of claim 8, wherein said cushion support member has a curved profile.

11. The method of claim 8, wherein a lower surface of said cushion support member is configured to abut against an interior surface of the door to thereby enhance fit and placement of said device on the door.

12. The method of claim 8, wherein said door engagement member and said cushion support member are molded from plastic.

13. The method of claim 8, further comprising a cushion cover, said cushion cover disposed over said cushion.

14. The method of claim 2, wherein said cushion cover is selected from the group consisting of cloth, plastic, vinyl, and leather.
